(19) United States
(12) Patent Application Publication
(10) Pub. No.: US 2023/0281400 A1
(43) Pub. Date: Sep. 7, 2023

(54) Systems and Methods for Pretraining Image Processing Models

(71) Applicant: Google LLC, Mountain View, CA (US)

(72) Inventors: Zirui Wang, San Francisco, CA (US); Jiahui Yu, Jersey City, NJ (US); Yuan Cao, Mountain View, CA (US); Wei Yu, Palo Alto, CA (US); Zihang Dai, Cupertino, CA (US)

(21) Appl. No.: 17/685,774

(22) Filed: Mar. 3, 2022

(51) Int. Cl. G06F 40/58; G06F 40/284; G06V 30/10; G06V 10/766

(52) U.S. Cl. CPC G06F 40/58; G06F 40/284; G06V 10/766; G06V 30/10

(57) ABSTRACT

Example embodiments of the present disclosure relate to systems and methods for pretraining image-processing models on weakly-supervised image-text pairs. The pretraining can include receiving a training sequence for the machine-learned image-processing model. The training sequence can include text tokens and image tokens. A prefix sequence can contain the image tokens. A remainder sequence can include a remainder set of the text tokens. The pretraining can include determining, using the prefix sequence as an input to the machine-learned image-processing model, an objective based on recovery of the remainder sequence. The pretraining can include updating one or more learnable parameters of the machine-learned image-processing model based on the objective.

### FIELD

The present disclosure relates generally to training machine-learned models. More particularly, aspects of the present disclosure relate to weakly supervised training of machine-learned image-processing models.

### BACKGROUND

Training machine-learned models can use large quantities of data. In some cases, supervised training can refer to training a model based on training examples that are individually curated to provide a certain training outcome (e.g., a curated collection of cat images to train an image-recognition model to recognize cats). For instance, a training objective can be to match a model output to a predetermined image label. In some cases, unsupervised training can refer to training a model with training examples that are not individually curated (e.g., crawled images, text, etc.). In some cases, training examples for unsupervised training can be collected with lower effort, but it can be challenging to determine a training objective.

### SUMMARY

Aspects and advantages of embodiments of the present disclosure will be set forth in part in the following description, or can be learned from the description, or can be learned through practice of the embodiments.

In one example aspect, the present disclosure provides an example system for training a machine-learned image-processing model. The example system includes one or more processors and one or more non-transitory, computer-readable media that store instructions that, when executed, cause the one or more processors to perform operations. In the example system, the operations include receiving a training sequence for the machine-learned image-processing model. In the example system, the training sequence includes text tokens and image tokens, a prefix sequence containing the image tokens, and a remainder sequence containing a remainder set of the text tokens. In the example system, the operations include determining, using the prefix sequence as an input to the machine-learned image-processing model, an objective based on recovery of the remainder sequence. In the example system, the operations include updating one or more learnable parameters of the machine-learned image-processing model based on the objective. In some embodiments of the example system, the machine-learned image-processing model is configured to bidirectionally attend over the prefix sequence and optionally evaluate a language modeling objective over the remainder sequence.

In one example aspect, the present disclosure provides an example method for training machine-learned image-processing model. The example method includes receiving, by a computing system having one or more processors, a training sequence for the machine-learned image-processing model. In the example method, the training sequence includes text tokens and image tokens, a prefix sequence containing the image tokens, and a remainder sequence containing a remainder set of the text tokens. The example method includes determining, by the computing system and using the prefix sequence as an input to the machine-learned image-processing model, an objective based on recovery of the remainder sequence. The example method includes updating, by the computing system, one or more learnable parameters of the machine-learned image-processing model based on the objective. In some embodiments of the example method, the machine-learned image-processing model is configured to bidirectionally attend over the prefix sequence and optionally evaluate a language modeling objective over the remainder sequence.

In one example aspect, the present disclosure provides an example system for implementing a machine-learned image-processing model. The example system includes one or more processors and one or more non-transitory, computer-readable media that store the machine-learned image-processing model. In the example system, the machine-learned image-processing model was trained over a weakly-supervised dataset containing images and associated text strings. In the example system, the machine-learned image-processing model includes one or more parameters updated based on a language modeling objective over a respective text string conditioned on a respective corresponding image. The example system includes the computer-readable media that store instructions that, when executed, cause the one or more processors to perform operations. In the example system, the operations include inputting image tokens to an encoder portion of the machine-learned image-processing model and outputting text tokens from a decoder portion of the machine-learned image-processing model. In some embodiments of the example system, the machine-learned image-processing model is configured to bidirectionally attend over the prefix sequence and optionally evaluate a language modeling objective over the remainder sequence. In some embodiments of the example system, the output text tokens are responsive to a query submitted via one or more text tokens input to the encoder portion.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example training objective implementation according to example embodiments of the present disclosure.

FIG. 2 depicts a block diagram of an example training objective implementation according to example embodiments of the present disclosure.

FIG. 3 depicts a block diagram of example downstream tasks performable by an example image-processing model pretrained according to example embodiments of the present disclosure.

FIG. 4A depicts a block diagram of an example computing system that can implement an example training objective according to example embodiments of the present disclosure.

FIG. 4B depicts a block diagram of an example computing device that can implement an example training objective according to example embodiments of the present disclosure.

FIG. 4C depicts a block diagram of an example computing device that can implement an example training objective according to example embodiments of the present disclosure.

FIG. 5 depicts a flow chart diagram of an example method to implement an example training objective according to example embodiments of the present disclosure.

Reference numerals that are repeated across plural figures are intended to identify the same features in various implementations.

### DETAILED DESCRIPTION

### Overview

Example embodiments according to aspects of the present disclosure are generally directed to techniques for improved pretraining of multimodal machine-learned models. For instance, a multimodal image-processing model can be trained to interpret, understand, and output semantic relationships between images and text (e.g., for image captioning, image-based reasoning, visual question answering, etc.). In some embodiments, the multimodal model can be trained to generate textual output based on an input image using a language-modeling pretraining objective. For instance, in some embodiments, the language-modeling pretraining objective can include a prefix-based objective: a training example can be used to obtain a training sequence split into a prefix and a textual remainder, and the objective can be configured to evaluate the recovery of the textual remainder by the model (e.g., via prediction/inference) when given the prefix. For example, a training example can contain an image and an associated text string. The image can be encoded into image tokens, and the text string can be encoded into text tokens. A prefix sequence can be obtained that includes the image tokens and optionally one or more text tokens. A remainder sequence can include the remaining text tokens. Pretraining can include predicting the remainder sequence with the model given the prefix sequence. The objective can be configured to evaluate recovery of the remainder sequence by the model. In this manner, for instance, the multimodal model can be trained to process multimodal data (e.g., image and text) using a single-modality objective (e.g., a generative language-modeling objective).

Prior techniques for pretraining multimodal models have generally required substantial curation of training data. For example, prior techniques have generally required a labeled dataset for learning each modality. For example, in some prior techniques, in order to capture alignment between images and text, labeled/curated object detection datasets are first used to train a supervised object detector for extracting region-of-interest features from images. Next, datasets of aligned image-text pairs are generally used for pretraining of a fusion model that can take as input the concatenation of the extracted region-of-interest features and the paired text. This pretraining approach generally requires multiple stages of fully supervised training.

In some other examples, due to the limited scale of human annotated data, various task-specific auxiliary losses have been used in the past in attempts to improve performance over noisier datasets. Other prior approaches have used training data from weakly labeled/aligned data crawled from the web, but generally such past approaches have relied on multiple independent single-mode processing pipelines (e.g., encoders/decoders for each modality). These design choices can complicate the pretraining process and create a bottleneck for further quality improvement, as well as inhibiting the use of powerful cross-modal context (e.g., cross-modal attention).

Advantageously, a prefix-based objective according to example aspects of the present disclosure can train an image-processing model for both generative language-modeling tasks while learning bidirectional attention pathways. For example, in some embodiments of pretraining, the multimodal model can bidirectionally attend over an input prefix and also obtain a recovered remainder in a generative fashion (e.g., sequentially predicting elements of an output sequence based on any preceding elements of the output sequence). In this manner, for example, the prefix-based objective according to example aspects of the present disclosure can leverage cross-modal context by bidirectionally attending over the prefix sequence, which can contain both image tokens and text tokens (e.g., bidirectional attention across modalities). Additionally, the remainder can be predicted using generative language modeling, further developing the capability of the model for unidirectional generative tasks. Compared to some prior methods that rely purely on bidirectional attention pathways (e.g., masked-language modeling), example pretraining objectives of the present disclosure can not only enjoy the benefits of learning bidirectional contextualized representation, but also can learn improved performance on open-ended text generation in language modeling. Furthermore, compared to some prior methods that rely on multiple objectives to train different attention configurations, example pretraining objectives can provide a single objective that can provide for the development and learning of both bidirectional attention pathways and generative language modeling skills, providing for more efficient pretraining in one pass (e.g., evaluating a single objective over the training data in one pass, pretraining the model in a single stage, etc.).

Additionally, a prefix-based objective according to example aspects of the present disclosure can exhibit high tolerance to noisy training datasets. Furthermore, example embodiments can train multimodal image-processing models with a single-modality language-modeling objective, simplifying the pretraining process flow and enabling implementation at scale. In this manner also, for instance, a prefix-based objective according to example aspects of the present disclosure can provide for processing at scale such that any deficiencies in quality of a noisy set of training data can be mitigated by processing the noisy training data in large quantities.

Example embodiments according to the present disclosure can provide a number of technical effects and benefits. For instance, some example embodiments can provide a streamlined pretraining process with fewer stages (e.g., a single stage), decreasing configuration overhead and opportunities for suboptimal arrangement. Similarly, some example embodiments can present a simplified pretraining objective for decreasing computational overhead for each training cycle. For instance, in some embodiments, an objective according to example aspects of the present disclosure can provide for pretraining in one pass (e.g., evaluating a single objective over the training data in one pass, pretraining the model in a single stage, etc.). For example, a simplified pretraining objective according to the present disclosure can provide for improved performance of a resulting model obtained with decreased computational cost. For example, training a multimodal image-processing model using a pretraining objective according to the present disclosure can decrease processing cycles, memory usage, communications bandwidth, and other computational resources used to obtain a pretrained model.

Accordingly, by providing a more efficient pretraining objective, example embodiments according to the present disclosure can offer improved performance at scale. For instance, training a large number of models and/or using a large number of training examples can be computationally intensive. Thus, a more efficient pretraining objective according to example embodiments according to the present disclosure can enable greater scalability of model training and deployment. By improving performance at scale, a more efficient pretraining objective according to example embodiments according to the present disclosure can improve the capacity and capabilities of computing systems large and small. For instance, the efficiency gains enjoyed at large scales can also be leveraged to implement pretraining routines in resource-constrained environments (e.g., on mobile devices).

Furthermore, by providing an objective that jointly develops bidirectional attention pathways and unidirectional language modeling performance, example embodiments according to aspects of the present disclosure can provide for pre-trained models that demonstrate improved performance across task domains. For instance, in real-world deployment scenarios in which tasks may not necessarily be neatly categorized into separate domains, a model trained with a pretraining approach according to example aspects of the present disclosure can provide for improved real-world performance in mixed or cross-domain tasks. For example, zero-shot transfer can be improved due to the combination of bidirectional attention training and generative language modeling training.

Additionally, for instance, a pretraining approach according to example aspects of the present disclosure can provide for implementation of a small number of models (e.g., one model) in place of many models (e.g., multiple models). This can decrease the computational complexity of deploying the models, training the models, updating the models, deactivating the models, etc. In this manner, for instance, decreased computational resources can be used to perform model operations with the techniques disclosed herein. Decreased storage can be used to store a small number of models (e.g., one model) in place of many models (e.g., multiple models). Decreased network transmissions can be used to implement a small number of models (e.g., one model) in place of many models (e.g., multiple models) on one or more remote device(s) (e.g., client devices connected to a server device). Efficiency of update and patch cycles can be improved by devoting resources (e.g., computational resources, human resources, etc.) to managing and versioning a small number of models (e.g., one model) in place of many models (e.g., multiple models). By using a model trained with a pretraining approach according to example aspects of the present disclosure, a target performance can be achieved with less computational overhead by leveraging a small number of models (e.g., one model) in place of many models (e.g., multiple models). Lower latency can be achieved by using a small number of models (e.g., one model) instead of switching between many models (e.g., multiple models).

Furthermore, systems and methods according to example aspects of the present disclosure are well suited to pretraining transformer models. For instance, example techniques described herein provide for pretraining objectives that leverage internal parallel structures and processing streams of a transformer model to attend bidirectionally over a prefix input to the model to recover a remainder associated with the prefix input. In some embodiments, transformer models can include effectively parallelized computation of multi-headed attention. In this manner, for instance, examples of inherently parallelizable transformer models can be better pretrained for immediate deployment and/or further fine-tuning, offering improvements in scalability and distributed computation by leveraging a small number of transformer models (e.g., one transformer model) in place of many varying models (e.g., multiple models) that may not offer the same advantages at scale.

With reference now to the Figures, example embodiments of the present disclosure will be discussed in further detail.

### Example Model Arrangements

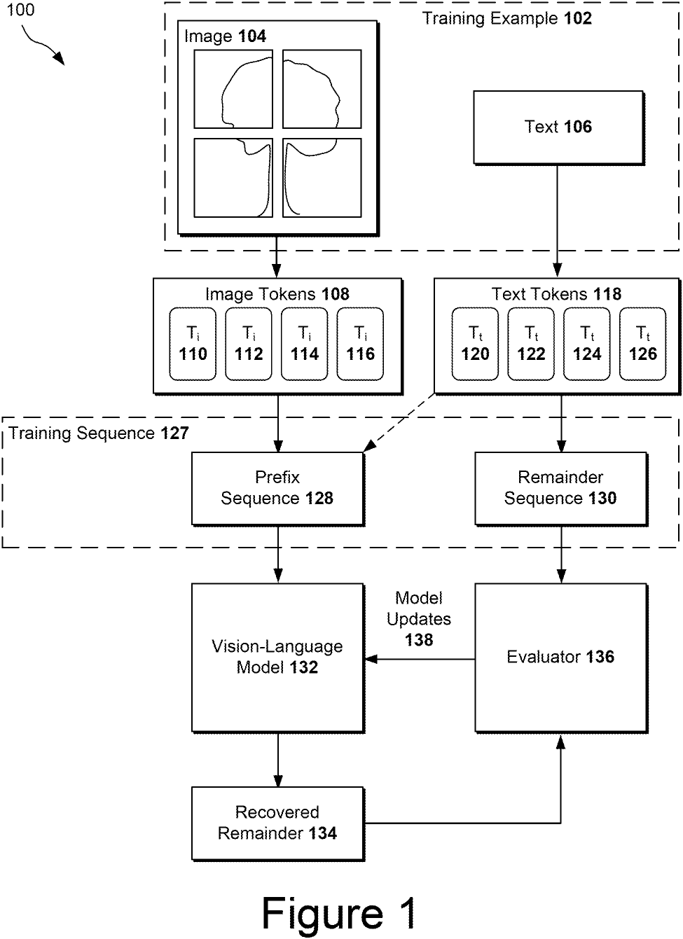

FIG. 1 depicts a block diagram of an example implementation of a pretraining objective according to the present disclosure. An image-processing pretraining pipeline 100 can begin with a training example 102 that contains an image 104 associated with text 106. The image 104 can be embedded into image tokens 108 (e.g., image tokens Tᵢ 110-116). The text can be embedded into text tokens 118 (e.g., text tokens Tₜ 120-126). The image tokens 108 and the text tokens 118 can be used to form a training sequence 127. The training sequence 127 can contain a prefix sequence 128 based on one or more of the image tokens 108 and optionally one or more of the text tokens 118. The training sequence 127 can contain a remainder sequence 130 based on one or more of the text tokens 118 (e.g., one or more text tokens 118 not included in the prefix sequence 128). An image-processing model 132 can receive the prefix sequence 128 as an input and generate a recovered remainder 134 as an output. The recovered remainder 134 can be evaluated with respect to the remainder sequence 130 by evaluator 136, which can provide for one or more model updates 138 based on the evaluation. In this manner, for example, the image-processing model 132 can be trained to generate textual information based on an image input optionally combined with a textual prompt.

In some embodiments, the training example 102 can be obtained from an unsupervised or weakly supervised training dataset. For example, the training example 102 can correspond to an image and text pairing crawled from a server, repository, or other storage (e.g., crawled from the web). For example, the text 106 can include a filename of the image 104. The text 106 can include metadata associated with the image 104, such as the contents of an alt-text field. The text 106 can include a caption associated with the image 104, or other textual data found in proximity to the image 104 (e.g., text from a shared node or container of a website, etc.). In some embodiments, the training dataset can be collected with little to no processing of the training examples therein. In some embodiments, the training dataset can be filtered to, for example, deduplicate examples, remove spurious entries, avoid sensitive or offensive materials, and the like. Although the training dataset is described in some examples as containing image-text pairs, example image-processing pretraining pipelines 100 can be agnostic to datatypes. For instance, in some embodiments, the prefix sequence 128 can contain only textual tokens or only image tokens. For instance, the image-processing pretraining pipeline 100 can be implemented in a number of iterations - in some iterations, image-text pairings can be used (e.g., to learn to semantically interpret images 104 in the language of text 106), and in some iterations, text-text pairings can be used (e.g., translation data to map the language of text 106 to another language).

In some embodiments, the image 104 can be embedded into image tokens 108. For instance, the image 104 can be directly embedded into image tokens 108 by patches. For example, the image 104 can be split into raw image patches (e.g., portions of the image selected by geometric boundaries) that can be mapped to flattened encodings. For example, raw image patches can be linearly projected into a token (e.g., a two-dimensional token, a one-dimensional token, etc.). In some embodiments, the image 104 can be embedded into image tokens 108 without additional image preprocessing upstream. For example, in some embodiments, the image tokens 108 can be directly embedded without first extracting or otherwise identifying regions of interest in the image 104 (e.g., with an object detection or other image recognition module). In this manner, for instance, the image tokens 108 can be determined based on geometric subdivisions of the image 104 (e.g., panels on a grid, etc.) instead of a semantic image processing technique. For instance, in this manner, the image tokens 108 can be embedded without need to first obtain or train an image-recognition model for parsing regions of interest.

In some embodiments, raw image patches can be reduced or contextualized by applying one or more convolutions (e.g., to the raw image prior to subdivision into patches, to the patches themselves, etc.). For example, one or more layers or blocks of a trained image-processing model can be used in generating the image tokens 108 from the image 104. For example, in some embodiments, one or more convolutions can be applied, optionally reducing a dimensionality of an image 104. For instance, for a raw image x having a heigh H, width W, and number of channels C (e.g., x ∈ ℝ^{H×W×C}), a token for the i-th patch can be expressed as

$${T}_{i} ∈$$

$${ℝ}^{D \times \frac{H W}{{P}^{2}}} ,$$

where P is the patch size dimension and D is an optional parameter corresponding to an input architecture of the image-processing model 132. For example, for transformer-based image-processing models 132, D can correspond to a hidden size of the transformer layer(s). In some embodiments, one or more convolutions can be performed using one or more layers of an image processing model. For example, one or more blocks of ResNet may be used to perform convolutions on an input image, or patches thereof. For instance, two, three, or four blocks of ResNet can be used to extract contextualized patches from an input image.

In some embodiments, the text 106 can be embedded into text tokens 118. The text tokens 118 can be generated from the text 106 by one or more language embedding techniques. For example, the text tokens 118 can be generated based on word embeddings, sub-word embeddings, or character embeddings (e.g., or combinations thereof).

In some embodiments, tokens in the training sequence 127 can include one or more positional embeddings. For instance, one or more positional embeddings can be added for image tokens 108 and text tokens 118. In some embodiments, positional embeddings can be added for image tokens 108 and text tokens 118 separately. In some embodiments, the positional encodings can be learnable. In some embodiments, the image-processing model 132 includes one or more transformer-based model components, and two-dimensional relative attention can be added to one or more layers for the image tokens 108.

In some embodiments, one or more parameters of an embedding layer for embedding the inputs (e.g., patches of the image 104, text 106) into tokens can be shared with an output layer of the image-processing model 132. For instance, in some embodiments, parameter(s) in the embedding layer can be shared with a decoder softmax layer for outputting a probability distribution over a vocabulary.

In some embodiments, the training sequence 127 includes a prefix sequence 128 assembled from image tokens 108 and optionally text tokens 118. In some embodiments, the prefix sequence 128 can include some image tokens 108 (e.g., all of image tokens 108) prepended to one or more text tokens 118 (e.g., a prefix set of text tokens 118, which can optionally be an empty set if no text tokens are in the prefix sequence 128). In some embodiments, the prefix sequence 128 can include all image tokens (e.g., single modality prefix). In some embodiments, the prefix sequence 128 can include all text tokens (e.g., single modality prefix). For example, one or more training iterations can be performed with a prefix sequence 128 assembled from image tokens 108 and optionally text tokens 118, and one or more subsequent training iterations can be performed with a prefix sequence 128 assembled only from text tokens 118 or other text tokens.

In some embodiments, the remainder sequence 130 includes a set of text tokens not contained within the prefix sequence 128 (e.g., a remainder set of the text tokens 118). In some embodiments, the remainder sequence 130 contains only text tokens (e.g., from text tokens 118). In some embodiments, the remainder sequence 130 includes a contiguous remainder of the text tokens 118 (e.g., a contiguous set of tokens not used in the prefix sequence 128). For example, text 106 can include a textual string that can be tokenized into a sequence of text tokens 118. One or more tokens (e.g., textual token 120) can be included in the prefix sequence 128. One or more other, remaining tokens (e.g., textual tokens 122, 124, 126; optionally contiguous tokens) can be included in the remainder sequence 130. In some embodiments, the remainder sequence 130 can contain a terminus of the textual string.

In some embodiments, a break point can be determined within the text tokens 118 to allocate the text tokens 118 among the prefix sequence 128 and the remainder sequence 130. For instance, a break point can be explicitly provided based on a quantity of tokens for the prefix sequence 128. In some embodiments, a break point can be changed or updated according to a desired scheme. For instance, in some embodiments, a break point can be randomly determined, such as randomly determined for each training example 102.

In some embodiments, the image-processing model 132 can be or otherwise include one or more machine-learned models configured to receive a sequence of tokens as input and output one or more tokens. For example, in some embodiments, image-processing model 132 can be or otherwise include a transformer-based model. For instance, image-processing model 132 can include a transformer encoder, a transformer decoder, or both. In some embodiments, image-processing model 132 includes a transformer-based encoder-decoder structure, and the prefix sequence 128 is provided to the encoder portion as an input for recovering the remainder sequence 130 as an output of the decoder portion.

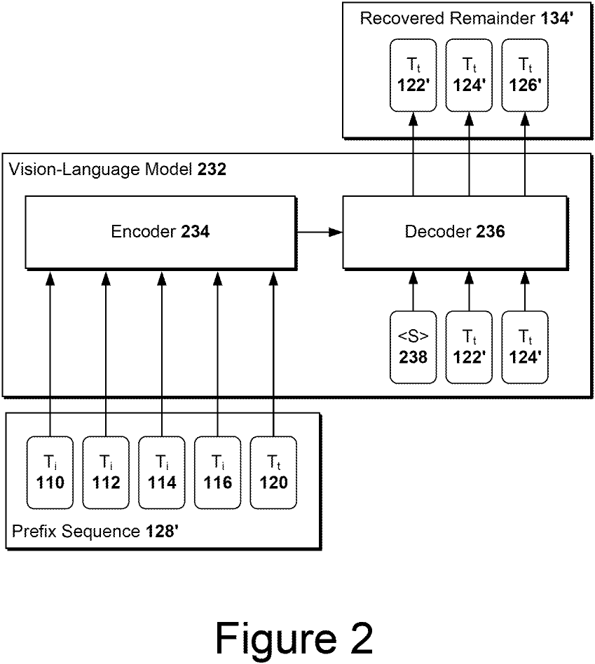

For example, FIG. 2 depicts an example model arrangement for an image-processing model 232 according to example aspects of the present disclosure. The image-processing model 232 can include an encoder portion 234 and a decoder portion 236. The encoder 234 can include a transformer-based encoder configured to receive an input sequence of tokens (e.g., the prefix sequence 128′). For example, the prefix sequence 128′ can include image tokens 110 to 116 and one or more text token(s) 120. For instance, a break point can be determined (e.g., randomly) and fall between text token 120 and text tokens 122, 124, and 126, such that the image tokens 110 to 116 are prepended to text token 120 to form the prefix sequence 128′. An encoding or other latent representation generated by the encoder 234 can be passed to the decoder 236 for recovery of a remainder of a sequence of tokens associated with the prefix sequence 128′.

In some embodiments, the encoder 234 can provide for self-attention over the prefix sequence 128′ (e.g., leveraging a transformer-based architecture). For example, the encoder 234 can be configured to bidirectionally attend over tokens in the prefix sequence 128′, such that an output of the encoder 234 can process a respective token in the prefix sequence 128′ in view of other tokens that can come before or after the respective token. In this manner, for example, bidirectional attention pathways can be learned and developed in example pretraining pipelines according to the present disclosure.

In some embodiments, the decoder 236 can generate recovered remainder 134′ (e.g., containing recovered text tokens 122′, 124′, and 126′). For instance, the decoder 236 can generate recovered remainder 134′ in a generative fashion. For example, the decoder 236 can sequentially generate the recovered tokens in view of preceding token(s), including the prefix sequence 128′ or encodings based thereon. For instance, a start token 238 can be input to the decoder 236. Based on the prefix sequence 128′ (e.g., or an encoding generated therefrom by the encoder 234), the decoder 236 can output recovered text token 122′. Recovered text token 122′ can be input to the decoder 236, and based on the preceding tokens (e.g., on the start token 238 and the prefix sequence 128′, or an encoding generated therefrom by the encoder 234), recovered text token 124′ can be output. Recovered text token 124′ can be input to the decoder 236, and based on the preceding tokens (e.g., on the start token 238, recovered text token 122′, and the prefix sequence 128′, or an encoding generated therefrom by the encoder 234), recovered text token 126′ can be output. In this manner, for example, a recovered remainder 134′ can be generated with attention over preceding tokens, as in a generative language modeling task. In this manner, for example, bidirectional attention pathways as well as unidirectional attention pathways for generative language modeling can be learned and developed in example pretraining pipelines according to the present disclosure.

In some embodiments, a pretraining objective according to example aspects of the present disclosure can provide for the development and learning of bidirectional attention pathways and generative language modeling skills. For instance, a single pretraining objective can provide for the development and learning of both bidirectional attention pathways and generative language modeling skills. Although the example embodiment illustrated in FIG. 2 depicts development of bidirectional attention pathways in an encoder portion of an image-processing model 232 and the development of generative language-modeling skills in a decoder portion of the model 232, it is contemplated that, for example, a decoder 236 could be provided with a prefix sequence 128′ prepended to one or more tokens for recovery (e.g., a start token 238), with attention permitted within the decoder 236 over the prefix tokens and masked over token(s) subsequent to the one or more tokens for recovery.

In some embodiments, based on the recovered remainder 134′ (e.g., as compared to an expected remainder sequence 130), one or more parameters of the image-processing model 232 can be updated. For example, with reference again to FIG. 1, the recovered remainder 134 can be evaluated (e.g., with an evaluator 136) to provide model updates 138 for one or more parameters of the image-processing model 132. For example, in some embodiments, a prefix-based language modeling objective can be implemented in an image-processing pretraining pipeline according to the present disclosure to evaluate the recovery of the remainder sequence 130. For instance, an example objective can include an expectation, for a training example sampled from a training dataset, and given a set of model parameters, of a log probability of the remainder sequence tokens given bidirectional attention over a prefix sequence and unidirectional attention over any preceding remainder sequence token(s). For instance, letting θ represent a set of model parameters for an image-processing model, D represent a training dataset, x represent a training sequence, T represent a length of the training sequence, and Tₚ represent a length of the prefix sequence (e.g., a randomly selected break point), an example prefix-based language-modeling objective can be expressed as

$${L}_{\text{PrefixLM}} = - {E}_{\text{x} \sim D} \left[{\sum }_{t = {T}_{\text{p}}}^{T} log {\text{P}}_{θ} \left({\text{x}}_{t} \left|{\text{x}}_{\left[{T}_{\text{p}} , t\right]}^{\text{U}} , {\text{x}}_{< {T}_{\text{p}}}^{\text{B}}\right)\right)\right]$$

where the superscript U indicates a unidirectional conditionality/attention over the indicated set of tokens and the superscript B indicates a bidirectional conditionality/attention over the indicated set of tokens. In this example, for instance, for a given image-text pair, an image token sequence of length Tᵢ can be prepended to a text sequence having a length Tₜ for the model to sample a prefix of length Tₚ, where Tᵢ≤ Tₚ ≤ Tₚ + Tₜ. In this manner, for instance, example pretraining objectives can leverage bidirectional attention on the prefix sequence while optionally only conducting autoregressive factorization on tokens in the remainder sequence.

In some embodiments, the evaluator 136 includes and example prefix-based objective as described herein. In some embodiments, the evaluator 136 includes only the prefix-based objective as described herein. For instance, in some embodiments, one or more pretraining cycles can leverage a single objective based on the prefix-based objectives described herein.

In some embodiments, pretraining can include prefix-based remainder recovery of text-only data as well as on image-text pairings. For example, in some embodiments, a pretraining recipe can include recovering (e.g., generatively predicting) one or more portions of text strings associated with images as well as recovering (e.g., generatively predicting) one or more portions of text strings associated with other portions of the text strings (e.g., without image tokens prepended thereto). In this manner, for instance, a single objective can be used for pretraining over both vision-language datasets and over textual corpora.

In some embodiments, an image-processing model pretrained with a pretraining pipeline 100 as described herein can be subsequently implemented to perform a number of downstream tasks. In some embodiments, the training procedures and techniques discussed herein can form part of a pretraining system or a fine-tuning system. For instance, the training of a machine-learned image-processing model can be completed in stages. A model can be pre-trained for general developing a general-purpose configuration and subsequently fine-tuned for specific tasks. Pre-training can include pursuit of unsupervised or weakly supervised objectives across large unlabeled training datasets, and can be followed by optionally supervised learning on smaller, sometimes labeled datasets in a fine-tuning stage. In some examples, an image-processing model pretrained with a pretraining pipeline 100 as described herein can be subsequently implemented to perform a number of downstream tasks with or without further fine-tuning. In some embodiments, the pretraining pipeline 100 as described herein can be implemented for fine-tuning a pretrained model.

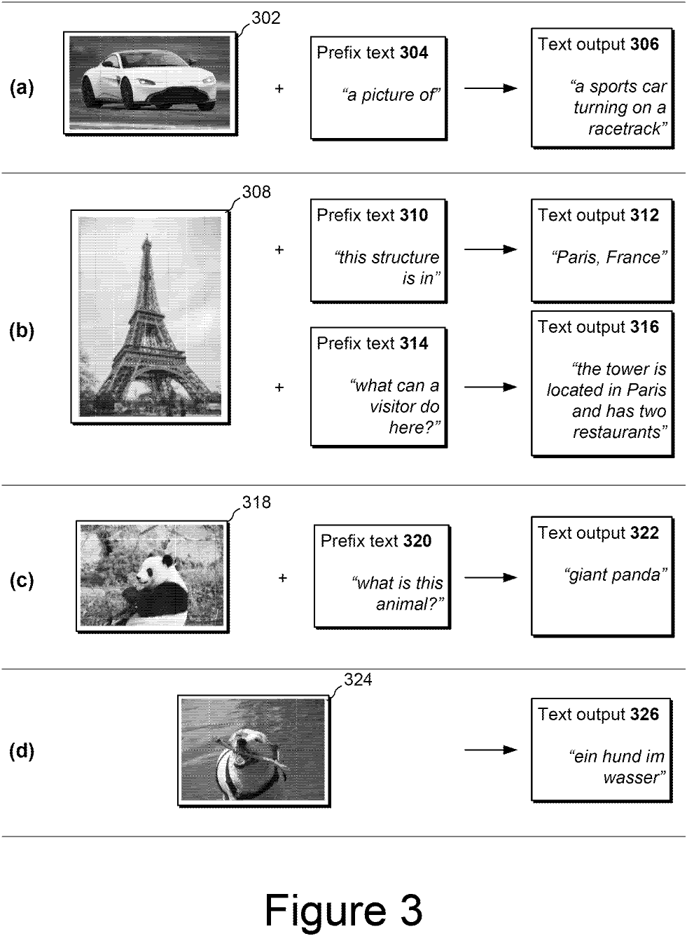

In some embodiments, downstream tasks can include vision-language processing tasks. For example, FIG. 3 illustrates a non-limiting selection of a variety of different types of downstream tasks. Subfigure (a) of FIG. 3 illustrates an image 302 that can be fed to the image-processing model (e.g., model 132, 232) as part of a prefix, optionally prepended to tokens based on prefix text 304, “a picture of”—in this manner, for example, using the terminology discussed herein with respect to pretraining, image tokens based on image 302 and text tokens based on prefix text 304 can form a prefix sequence input to the image-processing model. The image-processing model can exercise bidirectional attention over the prefix sequence to understand that the desired “remainder” that would be associated with the prefix is a descriptive text string or caption. The image-processing model can then exercise language modeling skills to generate text output 306 that operates as a remainder, “a sports car turning on a racetrack.” In some embodiments, this type of downstream task can be considered a captioning task. In some embodiments, a captioning task can be performed in a zero-shot implementation, in which the image-processing model has not been previously pretrained or fine-tuned for the task (e.g., not trained with curated caption data, images from the runtime set, etc.). In some embodiments, the model can be trained with a naïve cross-entropy loss only (e.g., instead of task-specific tricks such as CIDEr optimization).

Subfigure (b) of FIG. 3 illustrates an image 308 that can be fed to the image-processing model (e.g., model 132, 232) as part of a prefix, optionally prepended to tokens based on prefix text 310, “this structure is in″-in this manner, for example, using the terminology discussed herein with respect to pretraining, image tokens based on image 308 and text tokens based on prefix text 310 can form a prefix sequence input to the image-processing model. The image-processing model can exercise bidirectional attention over the prefix sequence to understand that the desired “remainder” that would be associated with the prefix is a text string that completes the prefix text phrase in view of the input image 308. The image-processing model can then exercise language modeling skills to generate text output 312 that operates as a remainder, “Paris, France.” In some embodiments, this type of downstream task can be considered a visual text completion task. In some embodiments, a visual text completion task can be performed in a zero-shot implementation, in which the image-processing model has not been previously pretrained or fine-tuned for the task (e.g., not trained with curated text completion data, images from the runtime set, etc.).

Subfigure (b) of FIG. 3 also illustrates an image 308 that can be fed to the image-processing model (e.g., model 132, 232) as part of a prefix, optionally prepended to tokens based on prefix text 314, “what can a visitor do here?”-in this manner, for example, using the terminology discussed herein with respect to pretraining, image tokens based on image 308 and text tokens based on prefix text 314 can form a prefix sequence input to the image-processing model. The image-processing model can exercise bidirectional attention over the prefix sequence to understand that the desired “remainder” that would be associated with the prefix is a text string that answers the question posed in prefix text in view of the input image 308. The image-processing model can then exercise language modeling skills to generate open-ended text output 316 that operates as a remainder that answers the question, “the tower is located in Paris and has two restaurants.” In some embodiments, this type of downstream task can be considered an open-ended visual question answering task. An open-ended nature of the task can include possible range of answers that is not limited to a particular set of answers, such that the response is freely generated based on the learned knowledge set of the model. In some embodiments, a visual question answering task can be performed in a zero-shot implementation, in which the image-processing model has not been previously pretrained or fine-tuned for the task (e.g., not trained with curated question-answer data, images from the runtime set, etc.). In some embodiments, fine-tuning for visual question answering can include providing a raw image and a corresponding question as inputs to the encoder and the decoder, respectively, and a task-specific linear classifier can be trained to predict an answer based on an activation corresponding to the last question token from the decoder.

Subfigure (c) of FIG. 3 illustrates an image 318 that can be fed to the image-processing model (e.g., model 132, 232) as part of a prefix, optionally prepended to tokens based on prefix text 320, “what is this animal?” -in this manner, for example, using the terminology discussed herein with respect to pretraining, image tokens based on image 318 and text tokens based on prefix text 320 can form a prefix sequence input to the image-processing model. The image-processing model can exercise bidirectional attention over the prefix sequence to understand that the desired “remainder” that would be associated with the prefix is a text string that answers the question posed in prefix text in view of the input image 318. The image-processing model can then exercise language modeling skills to generate text output 322 that operates as a remainder that answers the question, “giant panda.” In some embodiments, this type of downstream task can be considered a generative visual question answering task. In some aspects, the task can include obtaining a desired answer that is generally associated with a limited set of pointed answers (e.g., here, the set of animal species, etc.). For instance, the model can be fine-tuned to output specific answers to pointed questions. However, the generative nature of the task can remain, as in some embodiments the image-processing mode generates the answer without constraint to any closed set of answers. In this manner, for instance, a generative image-processing model according to the present disclosure can perform both open-ended visual question answering tasks and generative visual question answering tasks. In some embodiments, a visual question answering task can be performed in a zero-shot implementation, in which the image-processing model has not been previously pretrained or fine-tuned for the task (e.g., not trained with curated question-answer data, images from the runtime set, etc.).

Subfigure (d) of FIG. 3 illustrates an image 324 that can be fed to the image-processing model (e.g., model 132, 232) as a prefix-in this manner, for example, using the terminology discussed herein with respect to pretraining, image tokens based on image 324 can form a prefix sequence input to the image-processing model. The image-processing model can exercise bidirectional attention over the prefix sequence to understand that the desired “remainder” that would be associated with the prefix is a text string descriptive of the input image 324. The image-processing model can then exercise language modeling skills to generate text output 326 that operates as a remainder associated with the image 324, “ein hund im wasser.” In some embodiments, this type of downstream task can be considered a captioning task. For example, as compared to Subfigure (a), a prefix text prompt is not needed to trigger generation of the caption. In some embodiments, a visual question answering task can be performed in a zero-shot implementation, in which the image-processing model has not been previously pretrained or fine-tuned for the task (e.g., not trained with curated question-answer data, images from the runtime set, etc.).

In some embodiments, an image-processing model can be pretrained with image and textual data and further pretrained with text-only data. In some embodiments, text-only data can be used for fine tuning for further learning of semantic relationships in language. In some embodiments, text-only data can be used for fine tuning for learning semantic relationships between languages. For example, an image-processing model can be pretrained to associate images with text using weakly supervised image-text pairings in a first language (e.g., English). In a fine-tuning procedure, the image-processing model can be fine-tuned on translation pairings (e.g., text-only data) between the first language and a second language (e.g., German). In this manner, for example, a downstream task can be performed with output in a second language when the model was only pre-trained in a first, different language. For instance, with respect to the example task in Subfigure (d) of FIG. 3, the model can be pretrained on English-language image-text pairings and fine-tuned on English-German translation data, such that the captioning task can be performed in German. In this manner, for example, cross-modality tasks can be performed, including zero-shot cross-modality tasks (e.g., zero-shot referring to the absence of training on, for instance, German-language image-text pairings).

In another example, an image-processing model can be pretrained to associate images with text using weakly supervised image-text pairings. In a fine-tuning procedure, the model can be trained on a text-only natural-language reasoning corpus in a same or different language. For example, in fine-tuning, a premise can be input to an encoder portion and a hypothesis can be input to a decoder portion for outputting a classification (e.g., a classification of a logical relationship, such as entailment, neutral, or contradiction, etc.). In some embodiments, at runtime an image can be input to the encoder as a premise and a textual hypothetical can be input to the decoder for classification. Based on the pretraining using image-text pairings and an objective according to the present disclosure, the image-processing model can understand the premise from the image and proceed with classification of the hypothesis. In this manner, for example, cross-modality tasks can be performed, including zero-shot cross-modality tasks (e.g., zero-shot referring to the absence of training on, for instance, curated image-premise pairings).

In some embodiments, an image-processing model pretrained according to example aspects of the present disclosure can also provide for improved performance on single-modality tasks. For example, in some embodiments, after pretraining on image-text pairings with a pretraining pipeline according to the present disclosure, an image-processing model can be implemented to perform text-only tasks, such as tasks generally related to, for instance, the GLUE benchmarks. The pretraining objectives of the present disclosure, providing for joint learning of bidirectional attention pathways and generative language modeling skills, can transfer from the image-text domain to perform tasks in a text-text domain.

In some embodiments, an image-processing model pretrained according to example aspects of the present disclosure can also provide for improved performance on image classification tasks. For example, in some embodiments, an average pooling of encoder outputs can be used as image features for predicting image classes.

### Example Results

A Present Example is described below for providing experimental results for an example prefix-based pretraining objective of the present disclosure. For the convolution stage, the Present Example uses the first three blocks (excluding the conv stem) of ResNet-101. During pretraining, the Present Example uses a 224 × 224 image resolution with a fixed patch size of 16 × 16, resulting in a patch sequence of length 14 × 14 as visual tokens. For the textual input, the Present Example uses a vocabulary size of 32.000 and a max sequence length of 256 in both the encoder and decoder. The Present Example uses an embedding dimension of 512 and 8 layers. The Present Example also shares parameters between the embedding and the decoder softmax output layer. The Present Example is pretrained on large-scale web datasets for both image-text and text-only inputs. For joint vision and language data, the Present Example uses the training set of Chao Jia, Yinfei Yang, Ye Xia, Yi-Ting Chen, Zarana Parekh, Hieu Pham, Quoc V Le, Yunhsuan Sung, Zhen Li, & Tom Duerig, Scaling Up Visual and Image-processing Representation Learning with Noisy Text Supervision, arXiv preprint arXiv:2102.05918, 2021, which contains about 1.8 billion noisy image-text pairs. The Present Example employs random resized cropping. For the text-only copora, the Present Example uses the Colossal Clean Crawled Corpus (C4) dataset presented in Colin Raffel, Noam Shazeer, Adam Roberts, Katherine Lee, Sharan Narang, Michael Matena, Yanqi Zhou, Wei Li, & Peter J Liu, Exploring the Limits of Transfer Learning with a Unified Text-to-Text Transformer, arXiv preprint arXiv:1910.10683, 2019, and followed its preprocessing steps. The dataset contains about 800 gigabytes of web crawled documents. The Present Example is pretrained for about 1 million steps from scratch. The Present Example is processed with the AdamW optimizer with β1 = 0.9, β2 = 0.999 and a weight decay of 0.01. The Present Example uses a warmed-up learning rate for the first 2% of updates to a peak value of 5×10⁻⁴, and then it linearly decays afterwards. The Present Example mixes the two pretraining datasets within each batch, which contains 4,096 image-text pairs and 512 text-only documents, sharded across 512 TPU v3 chips.

Table 1 provides example results comparing two baseline configurations with the Present Example. The baseline “Decoder-only with language modeling objective” provides an example baseline using a traditional language-modeling objective with only unidirectional attention within a decoder generating the output. The baseline “Encoder-decoder with span corruption objective” provides an example baseline using a traditional span-corruption objective with only bidirectional attention. The Present Example outperforms both baselines.

TABLE 1

Example Results

| Configuration | VQA Acc | Zero-Shot Caption (B@4/C) |
|---|---|---|
| Decoder-only with language modeling objective | 64.48 | 17.7/63.4 |
| Encoder-decoder with span corruption objective | 66.23 | 17.4/66.2 |
| The Present Example | 67.43 | 18.2/68.3 |

### Example Devices and Systems

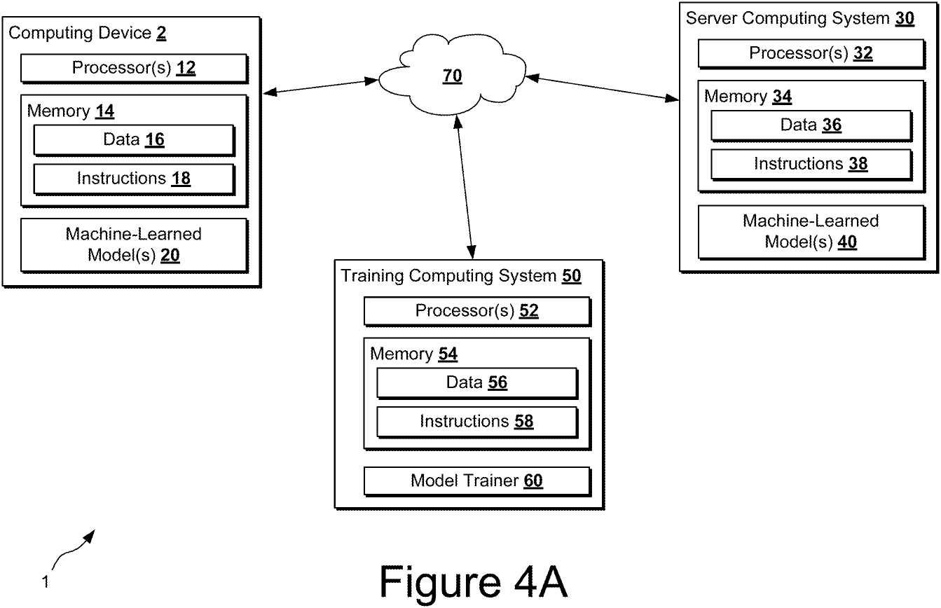

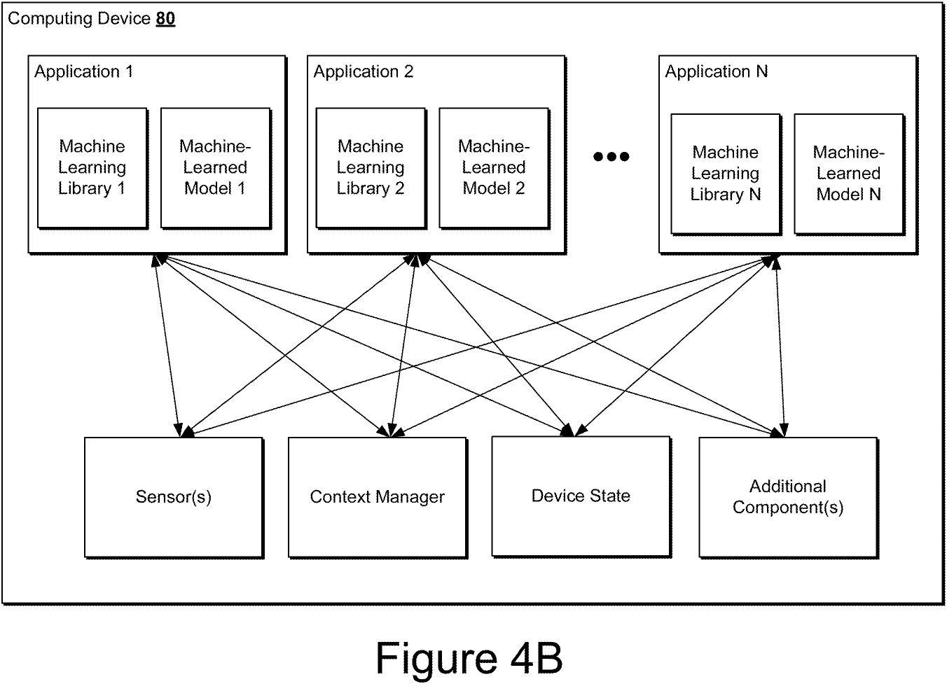

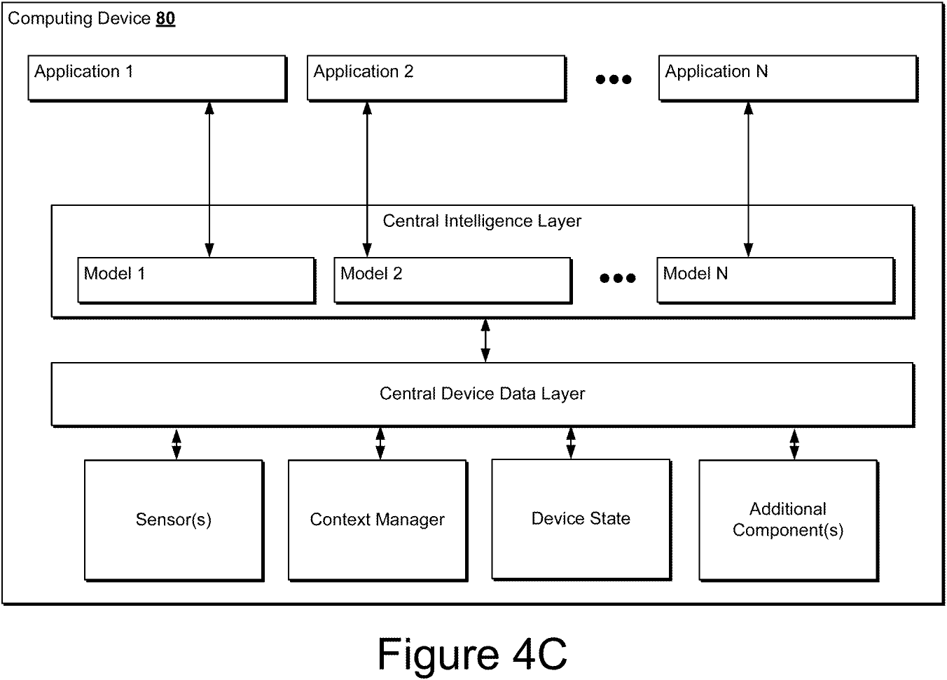

FIG. 4A depicts a block diagram of an example computing system 1 that can implement a machine-learned image-processing model pretraining pipeline according to example embodiments of the present disclosure. The system 1 includes a computing device 2, a server computing system 30, and a training computing system 50 that are communicatively coupled over a network 70.

The computing device 2 can be any type of computing device, such as, for example, a mobile computing device (e.g., smartphone or tablet), a personal computing device (e.g., laptop or desktop), a workstation, a cluster, a gaming console or controller, a wearable computing device, an embedded computing device, or any other type of computing device. In some embodiments, the computing device 2 can be a client computing device. The computing device 2 can include one or more processors 12 and a memory 14. The one or more processors 12 can be any suitable processing device (e.g., a processor core, a microprocessor, an ASIC, an FPGA, a controller, a microcontroller, etc.) and can be one processor or a plurality of processors that are operatively connected. The memory 14 can include one or more non-transitory computer-readable storage media, such as RAM, ROM, EEPROM, EPROM, flash memory devices, magnetic disks, etc., and combinations thereof. The memory 14 can store data 16 and instructions 18 which are executed by the processor 12 to cause the user computing device 2 to perform operations (e.g., to perform operations implementing an image-processing model pretraining pipeline as described herein, or implementing an image-processing model trained thereby, etc.).

In some implementations, the user computing device 2 can store or include one or more machine-learned models 20. For example, the machine-learned models 20 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). In some embodiments, machine-learned model 20 includes an image-processing model (e.g., model 132, 232, etc.).

In some implementations, one or more machine-learned models 20 can be received from the server computing system 30 over network 70, stored in the computing device memory 14, and used or otherwise implemented by the one or more processors 12. In some implementations, the computing device 2 can implement multiple parallel instances of a machine-learned model 20 (e.g., to perform parallel pretraining across multiple instances of an image-processing model pretraining pipeline).

Additionally, or alternatively, one or more machine-learned models 40 can be included in or otherwise stored and implemented by the server computing system 30 that communicates with the computing device 2 according to a client-server relationship. For example, the machine-learned models 40 can be implemented by the server computing system 40 as a portion of a web service (e.g., a model training/pretraining service, such as to provide to the computing device 2 one or more trained/pretrained models). For instance, the server computing system 30 can communicate with the computing device 2 over a local intranet or internet connection. For instance, the computing device 2 can be a workstation or endpoint in communication with the server computing system 30, with implementation of the model 40 on the server computing system 30 being remotely performed and an output provided (e.g., cast, streamed, etc.) to the computing device 2. Thus, one or more models 20 can be stored and implemented at the user computing device 2 or one or more models 40 can be stored and implemented at the server computing system 30.

The computing device 2 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 30 can include one or more processors 32 and a memory 34. The one or more processors 32 can be any suitable processing device (e.g., a processor core, a microprocessor, an ASIC, an FPGA, a controller, a microcontroller, etc.) and can be one processor or a plurality of processors that are operatively connected. The memory 34 can include one or more non-transitory computer-readable storage media, such as RAM, ROM, EEPROM, EPROM, flash memory devices, magnetic disks, etc., and combinations thereof. The memory 34 can store data 36 and instructions 38 which are executed by the processor 32 to cause the server computing system 30 to perform operations (e.g., to perform operations implementing an image-processing model pretraining pipeline as described herein, or implementing an image-processing model trained thereby, etc.).

In some implementations, the server computing system 30 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 30 can store or otherwise include one or more machine-learned models 40. For example, the models 40 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some embodiments, the server computing system 30 can implement an image-processing model trained according to the present disclosure for performing a plurality of tasks. In some embodiments, the server computing system 30 can implement a plurality of machine-learned models based on an image-processing model trained according to the present disclosure for performing a plurality of tasks. For example, in some embodiments, an image-processing model can be pretrained with a prefix-based objective according to the present disclosure. One or more variants of the model can be generated by fine-tuning the variant(s) for different downstream tasks (e.g., tasks of the types described with respect to FIG. 3, or other tasks, etc.). In some embodiments, one or more of the variants can be distilled to reduce the size of the variant(s) for deployment or other implementation. In this manner, for example, a server computing system 30 can deploy or otherwise implement model(s) for a plurality of different tasks based on a single base model pretrained according to example aspects of the present disclosure, increasing efficiency of processing, storage, and service of the model(s) to perform the tasks.

The computing device 2 or the server computing system 30 can train example embodiments of a machine-learned image-processing model (e.g., including models 20 or 40) using a pretraining pipeline according to the present disclosure. In some embodiments, the computing device 2 or the server computing system 30 can train example embodiments of a machine-learned image-processing model (e.g., including models 20 or 40) using a pretraining pipeline according to the present disclosure via interaction with the training computing system 50. In some embodiments, the training computing system 50 can be communicatively coupled over the network 70. The training computing system 50 can be separate from the server computing system 30 or can be a portion of the server computing system 30.

The training computing system 50 can include one or more processors 52 and a memory 54. The one or more processors 52 can be any suitable processing device (e.g., a processor core, a microprocessor, an ASIC, an FPGA, a controller, a microcontroller, etc.) and can be one processor or a plurality of processors that are operatively connected. The memory 54 can include one or more non-transitory computer-readable storage media, such as RAM, ROM, EEPROM, EPROM, flash memory devices, magnetic disks, etc., and combinations thereof. The memory 54 can store data 56 and instructions 58 which are executed by the processor 52 to cause the training computing system 50 to perform operations (e.g., to perform operations implementing an image-processing model pretraining pipeline as described herein, or implementing an image-processing model trained thereby, etc.). In some implementations, the training computing system 50 includes or is otherwise implemented by one or more server computing devices.

The model trainer 60 can include a pretraining pipeline for training machine-learned image-processing models using a prefix-based objective according to the present disclosure. Parameters of the image-processing model(s) can be trained, in some embodiments, using various training or learning techniques, such as, for example, backwards propagation of errors. For example, an objective or loss (e.g., a prefix-based objective according to the present disclosure) can be backpropagated through the pretraining pipeline(s) to update one or more parameters of the model(s) (e.g., based on a gradient of the loss function). Various determinations of loss can be used, such as mean squared error, likelihood loss, cross entropy loss, hinge loss, or various other loss functions. Gradient descent techniques can be used to iteratively update the parameters over a number of training iterations. In some implementations, performing backwards propagation of errors can include performing truncated backpropagation through time. The pretraining pipeline can perform a number of generalization techniques (e.g., weight decays, dropouts, etc.) to improve the generalization capability of the models being trained.

The model trainer 60 can include computer logic utilized to provide desired functionality. The model trainer 60 can be implemented in hardware, firmware, or software controlling a general-purpose processor. For example, in some implementations, the model trainer 60 includes program files stored on a storage device, loaded into a memory, and executed by one or more processors. In other implementations, the model trainer 60 includes one or more sets of computer-executable instructions that are stored in a tangible computer-readable storage medium such as RAM, hard disk, or optical or magnetic media.

The network 70 can be any type of communications network, such as a local area network (e.g., intranet), wide area network (e.g., Internet), or some combination thereof and can include any number of wired or wireless links. In general, communication over the network 70 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 4A illustrates one example computing system that can be used to implement the present disclosure. Other computing systems can be used as well. For example, in some implementations, the computing device 2 can include the model trainer 60. In such implementations, a pretraining pipeline can be used locally at the computing device 2 (e.g., to train an image-processing model, such as a model 132, 232). In some of such implementations, the computing device 2 can implement the model trainer 60 to personalize the model(s) based on device-specific data.

FIG. 4B depicts a block diagram of an example computing device 80 that performs according to example embodiments of the present disclosure. The computing device 80 can be a user computing device or a server computing device. The computing device 80 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 4B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 4C depicts a block diagram of an example computing device 80 that performs according to example embodiments of the present disclosure. The computing device 80 can be a user computing device or a server computing device. The computing device 80 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 80.

The central intelligence layer can communicate with a central device data layer. The central device data layer can be a centralized repository of data for the computing device 80. As illustrated in FIG. 4C, the central device data layer can communicate with a number of other components of the computing device, such as, for example, one or more sensors, a context manager, a device state component, or additional components. In some implementations, the central device data layer can communicate with each device component using an API (e.g., a private API).

### Example Methods

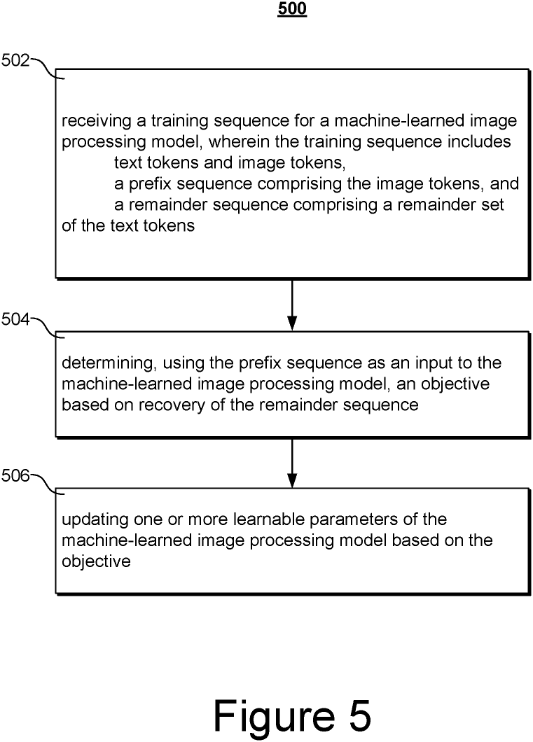

FIG. 5 depicts a flow chart diagram of an example method 500 to perform according to example embodiments of the present disclosure. Although FIG. 5 depicts operations performed in a particular order for purposes of illustration and discussion, the methods of the present disclosure are not limited to the particularly illustrated order or arrangement. The various operations of example method 500 can be omitted, rearranged, combined, or adapted in various ways without deviating from the scope of the present disclosure. In some embodiments, one or more operations of example method 500 can be implemented using any one or more of the computing systems described herein (e.g., computing device 2, server computing system 30, training computing system 50, etc.).

At 502, the method 500 can include receiving a training sequence for a machine-learned image-processing model. In some embodiments, the training sequence can include text tokens and image tokens. In some embodiments, a prefix sequence of the training sequence can include one or more image tokens. In some embodiments, a remainder sequence of the training sequence can include one or more text tokens, such as a set of text tokens remaining after text tokens (if any) are allocated to the prefix sequence. For example, image tokens and text tokens and their placement into prefix sequences and remainder sequences is described in various examples with respect to FIGS. 1 and 2.

In some embodiments, for example, the training sequence is based on a training example obtained from a training dataset. For instance, the training example can include an image associated with a text string, such that the image tokens are respectively based on patches of the image, and the text tokens are respectively based on portions of the text string. In some embodiments, the data from the training example is allocated to prefix sequence or the remainder sequence based on a break point. For example, the method 500 can include determining a random break point in the text string, with the prefix set being based on portions of the text string before the random break point and the remainder set being based on portions of the text string after the random break point.

At 504, the method 500 can include determining, using the prefix sequence as an input to the machine-learned image-processing model, an objective based on recovery of the remainder sequence. For example, in some embodiments, an objective can be configured such that the model is tasked with predicting one or more words to follow a prefix. For example, in some embodiments, a prefix can include an image and a first portion of an input sentence or phrase, such that an example objective can include predicting a remainder portion of the input sentence or phrase. In this manner, for example, a “missing” remainder can be “recovered” by the model. In some embodiments, a remainder sequence can be recovered from an image directly. For instance, a prefix sequence can contain image tokens based on an input image, and a caption or other related textual material can be recovered/predicted as text associated with the image. In this manner, for example, related textual material can be recovered/predicted based on an input prefix sequence. For example, recovery/prediction of text tokens is described in various examples with respect to FIGS. 1 and 2.

In some embodiments, the machine-learned image-processing model is configured to bidirectionally attend over the prefix sequence. For example, in some embodiments, the machine-learned image-processing model is configured with an encoder-decoder architecture. The prefix sequence can be input to the encoder, and in some examples the encoder can be configured to bidirectionally attend over its inputs. In some examples, the decoder can be trained to generatively predict a remainder sequence based on an output of the encoder (e.g., based on the bidirectional attention pathways of the encoder). For instance, the decoder can be trained to sequentially output one or more tokens based on unidirectional attention over any preceding input tokens (e.g., with an output token forming an input for processing of the next output token). In this manner, for example, an objective can include a generative language-modeling loss over the remainder sequence, such as a language-modeling loss is based on an autoregressive factorization of a probability of recovering one or more tokens of the remainder sequence conditioned on one or more preceding tokens in the remainder sequence. Example encoder-decoder architectures are described in various examples with respect to FIG. 2.

At 506, the method 500 can include updating one or more learnable parameters of the machine-learned image-processing model based on the objective. In some embodiments, 506 can include a pretraining operation. For instance, a model can be pretrained (e.g., on large quantities of data) for subsequent fine-tuning (e.g., on smaller amounts of curated data, such as annotated or labeled training datasets). In some embodiments, the method 500 includes fine-tuning a plurality of variants of the machine-learned image-processing model for a respective plurality of different downstream tasks. For instance, a number of example downstream tasks are discussed with respect to FIG. 3. In some embodiments, fine-tuned model variants can be distilled for deployment (e.g., deployment on a server, on client devices, etc.).

In some embodiments, the objective can be implemented in a similar or different configuration as the image-text prefix-remainder objective configurations described herein with respect to FIGS. 1 and 2. For example, in some embodiments, the objective can be evaluated over purely textual prefixes. For instance, the training sequence can include textual information only. For example, a prefix can include textual information in a first language and the remainder can include textual information in another language. In this manner, for example, the model can be trained to learn cross-language semantic relationships.

In some embodiments, for example, pretraining can include evaluating the objective over image-text pairings and subsequent fine-tuning can include evaluating the objective over text-text pairings (e.g., curated or otherwise labeled pairings, etc.). For instance, in some embodiments, the fine-tuning training sequences can include textual information only.

In some embodiments, cross-domain semantic relationships can be leveraged in zero-shot or few-shot image processing. For example, in some embodiments, a model can perform image-processing tasks and provide output in a target language based on a training recipe that was not based on or did not include image-text pairings in the target language. For example, a prefix can include textual information in a first language and the remainder can include textual information in another language. In this manner, for example, the model can be trained to learn cross-language semantic relationships. In this manner, for instance, image-based translation tasks or other cross-domain image-processing tasks can be performed using a model fine-tuned using curated, text-only translation data between a subject language and a target language.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of′ example elements listed therein, etc. Also, terms such as “based on” should be understood as “based at least in part on.”

What is claimed is:

1. A system for training a machine-learned image-processing model, comprising:
one or more processors; and
one or more non-transitory, computer-readable media that store instructions that, when executed, cause the one or more processors to perform operations, the operations comprising:
receiving a training sequence for the machine-learned image-processing model, wherein the training sequence comprises
text tokens and image tokens,
a prefix sequence comprising the image tokens, and
a remainder sequence comprising a remainder set of the text tokens;
determining, using the prefix sequence as an input to the machine-learned image-processing model, an objective based on recovery of the remainder sequence; and
updating one or more learnable parameters of the machine-learned image-processing model based on the objective.

2. The system of claim 1, wherein the machine-learned image-processing model is configured to bidirectionally attend over the prefix sequence.

3. The system of claim 2, wherein the objective comprises a language-modeling loss over the remainder sequence.

4. The system of claim 3, wherein the language-modeling loss is based on an autoregressive factorization of a probability of recovering one or more tokens of the remainder sequence conditioned on one or more preceding tokens in the remainder sequence.

5. The system of claim 1, wherein the prefix sequence comprises the image tokens prepended to a prefix set of the text tokens.

6. The system of claim 5, wherein:
the training sequence is based on a training example obtained from a training dataset, the training example comprising an image associated with a text string, wherein
the image tokens are respectively based on patches of the image, and
the text tokens are respectively based on portions of the text string; and
wherein the operations comprise:
determining a random break point in the text string, the prefix set being based on portions of the text string before the random break point and the remainder set being based on portions of the text string after the random break point.

7. The system of claim 1, wherein the operations comprise:
inputting the prefix sequence to an encoder portion of the machine-learned image-processing model; and
outputting a recovered remainder sequence from a decoder portion of the machine-learned image-processing model.

8. The system of claim 1, wherein the operations comprise:
fine-tuning a plurality of variants of the machine-learned image-processing model for a respective plurality of different downstream tasks; and
distilling the plurality of variants for deployment.

9. The system of claim 1, wherein the operations comprise:
fine-tuning the machine-learned image-processing model on a textual dataset; and
implementing the machine-learned image-processing model with zero-shot transfer to an image-processing modality.

10. The system of claim 9, wherein:
the training sequence is based on a training example obtained from a training dataset in a first domain;
the textual dataset is in a translation domain bridging the first domain and a second domain; and
implementing the machine-learned image-processing model with zero-shot transfer to the image-processing modality comprises generating textual output in the second domain.

11. The system of claim 10, wherein the first domain is composed of data in a first language, the second domain is composed of data in a second language, and the translation domain comprises translation data from the first language to a second language.

12. The system of claim 3, wherein the objective consists of the language-modeling loss.

13. A method for training a machine-learned image-processing model, comprising:
receiving, by a computing system comprising one or more processors, a training sequence for the machine-learned image-processing model, wherein the training sequence comprises
text tokens and image tokens,
a prefix sequence comprising the image tokens, and
a remainder sequence comprising a remainder set of the text tokens;
determining, by the computing system and using the prefix sequence as an input to the machine-learned image-processing model, an objective based on recovery of the remainder sequence; and
updating, by the computing system, one or more learnable parameters of the machine-learned image-processing model based on the objective.

14. The method of claim 13, wherein the machine-learned image-processing model is configured to bidirectionally attend over the prefix sequence.

15. The method of claim 13, wherein the objective comprises a language-modeling loss over the remainder sequence.

16. The method of claim 15, wherein the language-modeling loss is based on an autoregressive factorization of a probability of recovering one or more tokens of the remainder sequence conditioned on one or more preceding tokens in the remainder sequence.

17. The method of claim 13, wherein the prefix sequence comprises the image tokens prepended to a prefix set of the text tokens.

18. The method of claim 13,
wherein the training sequence is based on a training example obtained from a training dataset, the training example comprising an image associated with a text string, wherein the image tokens are respectively based on patches of the image, and wherein the text tokens are respectively based on portions of the text string; and
wherein the method comprises:
determining a random break point in the text string, the prefix set being based on portions of the text string before the random break point and the remainder set being based on portions of the text string after the random break point.

19. A system for implementing a machine-learned image-processing model, comprising:
one or more processors; and
one or more non-transitory, computer-readable media that store:
the machine-learned image-processing model, wherein the machine-learned image-processing model was trained over a weakly-supervised dataset comprising images and associated text strings, wherein the machine-learned image-processing model comprises one or more parameters updated based on a language modeling objective over a respective text string conditioned on a respective corresponding image; and
instructions that, when executed, cause the one or more processors to perform operations, the operations comprising:
inputting image tokens to an encoder portion of the machine-learned image-processing model; and
outputting text tokens from a decoder portion of the machine-learned image-processing model.

20. The system of claim 19, wherein the output text tokens are responsive to a query submitted via one or more text tokens input to the encoder portion.
